(19) United States
(12) Patent Application Publication
(10) Pub. No.: US 2021/0132605 A1
(43) Pub. Date: May 6, 2021

(54) System and Method for Overriding an Automated Vehicle Steering Mode of a Vehicle

(71) Applicant: Deere & Company, Moline, IL (US)

(72) Inventors: Frederick W. Nelson, Waukee, IA (US); Timothy A. Wilcox, Cissna Park, IL (US)

(21) Appl. No.: 16/670,578

(22) Filed: Oct. 31, 2019

(51) Int. Cl. G05D 1/00; B62D 5/00; B62D 6/00; B60W 10/20

(52) U.S. Cl. CPC G05D 1/0061; B60W 10/20; B62D 6/008; B62D 5/006

(57) ABSTRACT

A vehicle steering system allowing for override of an automated steering mode, the system comprising: a vehicle steering mechanism; a movement module disposed on the vehicle steering mechanism, the sensor configured to detect movement of the vehicle steering mechanism of the vehicle steering system and generate a movement signal; a data transfer unit in wireless communication with the movement module and configured to receive and transmit the movement signal; and a steering control unit configured to allow for at least one of steering of the vehicle in a manual steering mode or an automated steering mode, the steering control unit in communication with the data transfer unit and configured to receive the movement signal and disable the automated vehicle steering mode upon receipt of the movement signal.

### FIELD OF THE DISCLOSURE

The present disclosure relates generally to a system and method for overriding an automated steering control of a vehicle and more specifically, to a system and method for overriding the automated steering control adaptable to a wide range of on-road and off-road vehicles with different steering mechanisms.

### BACKGROUND OF THE DISCLOSURE

Current automatic steering systems for off-road vehicles, such as the commercially available John Deere AutoTrac™ assisted steering system for tractors, typically require an auxiliary electro hydraulic steering control system to interact with the steering system on the vehicle. A combination of GPS system signals and signals from on-board sensors are processed to provide automatic guidance of the vehicle. An electro hydraulic valve, a steered wheel angle sensor, and steering wheel movement sensor for operator override are required to control interaction of the manual system with the automatic system. Such an automatic system takes many hours to install and requires knowledge of the steering, hydraulic, and electrical systems on the vehicle. The automatic system must be specifically adapted to the particular steering system on the vehicle and, in fact, use may be limited on some vehicles, such as those with dual-path hydrostatic steering.

### SUMMARY OF THE DISCLOSURE

According to an aspect of the present disclosure, a vehicle steering system allowing for override of an automated steering mode, the system comprising: a vehicle steering mechanism; a movement module disposed on the vehicle steering mechanism, the sensor configured to detect movement of the vehicle steering mechanism of the vehicle steering system and generate a movement signal; a data transfer unit in wireless communication with the movement module and configured to receive and transmit the movement signal; and a steering control unit configured to allow for at least one of steering of the vehicle in a manual steering mode or an automated steering mode, the steering control unit in communication with the data transfer unit and configured to receive the movement signal and disable the automated vehicle steering mode upon receipt of the movement signal.

According to another aspect of the present disclosure, a method for overriding an automated steering mode of a vehicle is provided. The method comprising: providing a movement module on a vehicle steering mechanism; detecting with the movement module movement of the vehicle steering mechanism by an operator; generating and transmitting a movement signal using the movement module, the signal representative of movement of the vehicle steering mechanism by the operator; receiving wirelessly the movement signal at a data transfer unit, the data transfer unit configured to receive and transmit the movement signal to steering control unit; and disabling, with the steering control unit, an automated vehicle steering mode thereby allowing the operator to steer the vehicle manually using the vehicle steering mechanism.

According to another aspect of the present disclosure, a vehicle steering apparatus, the apparatus comprising: a vehicle steering mechanism; a movement module disposed on the vehicle steering mechanism, the sensor configured to generate and transmit a movement signal representative of the movement of the vehicle steering mechanism; a data transfer unit in wireless communication with the movement module, the data transfer configured to receive and transmit the movement signal; and a steering control unit configured to receive the movement signal from the data transfer, compare the movement signal against a predetermined threshold value, and disable an automated vehicle steering mode when the movement signal satisfies the predetermined threshold value.

Other features and aspects will become apparent by consideration of the detailed description and accompanying drawings.

### BRIEF DESCRIPTION OF THE DRAWINGS

The detailed description of the drawings refers to the accompanying figures in which:

FIG. 1A is a perspective view of a vehicle steering apparatus on an agricultural vehicle;

FIG. 1B is a block diagram representation of a vehicle steering system and its components;

FIG. 2 is a block diagram representation of a steering control unit and a feedback device; and

FIG. 3 is a flowchart representation of a method of overriding an automated vehicle steering system by manual intervention by an operator.

### DETAILED DESCRIPTION OF THE DRAWINGS

With the advent of mechanization and automation technologies, significant portions of certain agricultural operations like planting, cultivating, spraying and harvesting are now routinely performed by an automated system with minimal intervention by an operator. These technologies allow for an operator to maximize his or her time and, ultimately, crop yields. For example, it becomes tiresome for an operator to manually drive agricultural vehicles in the fields to perform these agricultural operations. In one example of such automation technology, a vehicle (e.g., tractor) and associated implement (e.g., planter) are equipped with an automated steering system allowing the vehicle to drive itself and the implement on a guidance line of one or more planned paths for a field with rows. Typically, the operator guides the vehicle to the first row and initiates operation of an automated steering system. Later, the automated steering system continues to navigate the vehicle and implement in the field according to the one or more planned paths, e.g., along subsequent guidance lines. An example of automated steering system is the John Deere AutoTrac™ system. Additionally, exemplary automated steering systems are further disclosed in the following patents, each of which are incorporated by reference in their entirety: U.S. Pat. Nos. 8,498,788, 8,738,238, and 10,254,765.

Accordingly, it can be appreciated by one of ordinary skill that various reasons exist for allowing an operator to quickly disable an automated steering mode of, for example, the John Deere AutoTrac™. For example, it may desirable to allow the operator to disable the automated steering mode for safety purposes such as uneven terrain or muddy ground conditions, or the presence of an obstacle, wildlife or person in the area of operation. Also, it may be advantageous to allow an operator to quickly disengage the automated steering mode during the unloading of a harvester into a grain cart while moving in the field. In this situation, the operator may temporary disable an automated steering mode (e.g., as found in AutoTrac™) while the operator drives the vehicle to complete unloading of the harvester's hopper into the grain cart.

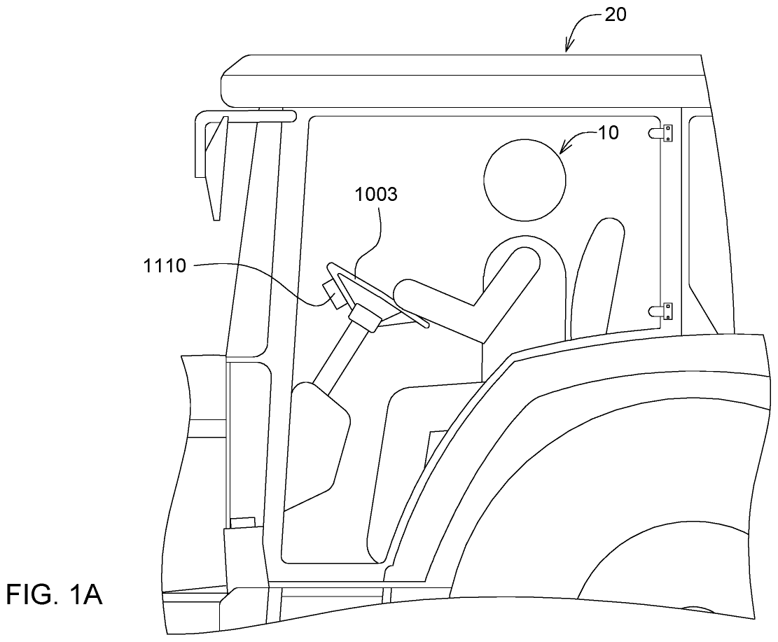

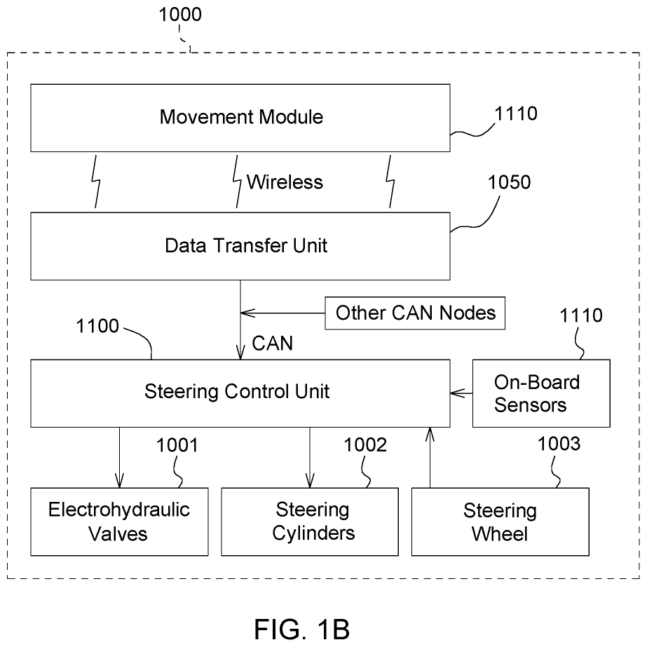

As shown in FIG. 1A, a movement module 1110 is associated with and, in one example, may be mounted to the steering wheel 1003 of a vehicle 20 with an operator 10. The movement module 1110 may include a processor with a rotation sensor, such as a vibrating structure gyroscope powered by battery or a microprocessor, to sense movement of the steering wheel 1003. For example, the movement module 1110 may be a microelectromechanical (MEM) type sufficiently sensitive to rotation or movement of the steering wheel 1003. Further, movement module 1110 may comprise a Bluetooth Low-Energy device integrated into a single structure with the rotation sensor. Alternatively, in another example, the movement module 1110 may comprise a Bluetooth Low-Energy device in a separate structure or housing joined to or otherwise associated with the rotation sensor.

As shown in FIG. 1B, a combination of GPS system signals and signals from on-board sensors (e.g., movement module 1110) and steering wheel 1003 are directly or indirectly received, processed and translated by steering control unit 1100 of vehicle steering system 1000 to control steering of the vehicle when in an automated or manual steering mode. In one example, signals from on-board sensors such as movement module 1110 pass through a data transfer unit 1050 to steering control unit 1100. Data transfer unit 1050 is configured to act as a data portal for a variety of sensors, controllers, other data transfer units and the like operating on a controller area network commonly referred to as a CAN Bus. It can be appreciated by one of ordinary skill that data transfer unit 1050 may be one of many nodes on the CAN bus and that data transfer unit 1050 may be configured to avoid producing traffic on the CAN. In this example, the vehicle steering system 1000 comprises a steering control unit 1100 configured to receive inputs from a GPS receiver (not shown), a steering wheel 1003, a movement module 1110—via data transfer unit 1050—and output commands to electrohydraulic valves 1001 which in turn control steering cylinders 1002 and the overall direction of vehicle 20. In another example, steering control unit 1100 further comprises an AutoTrac controller that utilizes the input from the GPS receiver to determine position information of a vehicle, the position information including the relative location of the vehicle within a field and one or more guidance lines and/or paths that the vehicle has already taken (e.g., a recorded position point) and/or will take (future position point) while in the field. In this example, an AutoTrac controller is automatically controlling the path of the vehicle along a guidance and could also be configured to receive as an input a movement signal 1111 for storing and comparison purposes.

With respect to movement module 1110, movement of the steering wheel 1003 is sensed by movement module 1110 and a corresponding movement signal 1111 is wirelessly sent to a uniquely paired data transfer unit 1050. The unique pairing of the movement module 1110 and data transfer unit 1050 through conventional Bluetooth or other communication protocols helps prevent interference from and inadvertent communication with other systems in proximity on the vehicle 20. Additionally, it is possible to encrypt the wireless signals between movement module 1110 and data transfer unit 1050 through conventional standards to further maintain the integrity of the various wireless signals.

In operation, the operator 10 may override the automated steering mode of vehicle steering system 1000 at any time by manually rotating the steering wheel 1003, thus allowing for manual control of the vehicle 20. Movement of the steering wheel 1003 by the operator 10 is sensed by movement module 1110 and a movement signal 1111 is created corresponding to rotation information (e.g., rotation rate) of steering wheel 1003. In one example, the movement signal 1111 is transmitted from the movement module 1110 to a data transfer unit 1050 unit utilizing a Bluetooth Low Energy device. It can be appreciated by one of ordinary skill that the movement signal 1111 is only transmitted by the data transfer unit 1050 to the steering control unit 1100 when it comprises a new reading from the rotation sensor of movement module 1110. Additionally, movement signal 1111 may contain other types of information: rotation information corresponding to rotation rate of the steering wheel 1003, power information corresponding to the available battery voltage of the movement module 1110 and signal strength information corresponding the relative signal strength and connection between the movement module 1110 and a data transfer unit 1050.

Upon processing of the movement signal 1111 by steering control unit 1100, automatic steering is disabled and operator 10 gains full control of vehicle steering system 1000. In another example, an operator could disable the automated steering mode of steering control unit 1100 upon some combination of manual rotation of the steering wheel 1003 and/or enabling or disabling other components associated with vehicle steering system 1000 When the steering control unit 1100 determines that operator 10 is attempting to enter into a self-driving mode, the automated steering mode of vehicle steering system 1000 can then be disabled or terminated.

In another example, the steering control unit 1100 will only disable automated steering mode if certain threshold sensitivity criteria are satisfied. In order to rule out unintentional, erroneous or accidental turn of steering wheel by operator 10, one or more threshold sensitivity criteria may be created or modified by the operator, the equipment manufacturer or another party. In one example, the sensitivity criteria are then used by the steering control unit 1100 to evaluate the movement of steering wheel 1003. However, it can be appreciated that this evaluation may be carried out by any number of processors, including processors associated with vehicle steering (e.g., steering electrohydraulic vales and cylinders) or an automated guidance system such as John Deere AutoTrac™. For example, the steering control unit 1100 may compare the movement signal 1111 transmitted by movement module 1110 against threshold sensitivity criteria relating to a percentage of total rotational travel of the steering wheel 1003 (e.g., more than 10% rotational travel). Alternatively, these sensitivity criteria could relate to a change in rotation rate or acceleration of the steering wheel 1003 (e.g., rotation greather than 40 degrees per second). In yet another example, the sensitivity criteria may relate to battery information (e.g., battery level is below 2 volts) of the movement module 1110 or signal information (e.g., no CAN message is received in 400 milliseconds) between any of the movement module 1110, data transfer unit 1050 or steering control unit 1100. In these examples, if the movement signal 1111 fails to satisfy the sensitivity criteria, the automated steering mode is permanently, or temporarily disabled and manual steering mode is permanently or temporarily enabled.

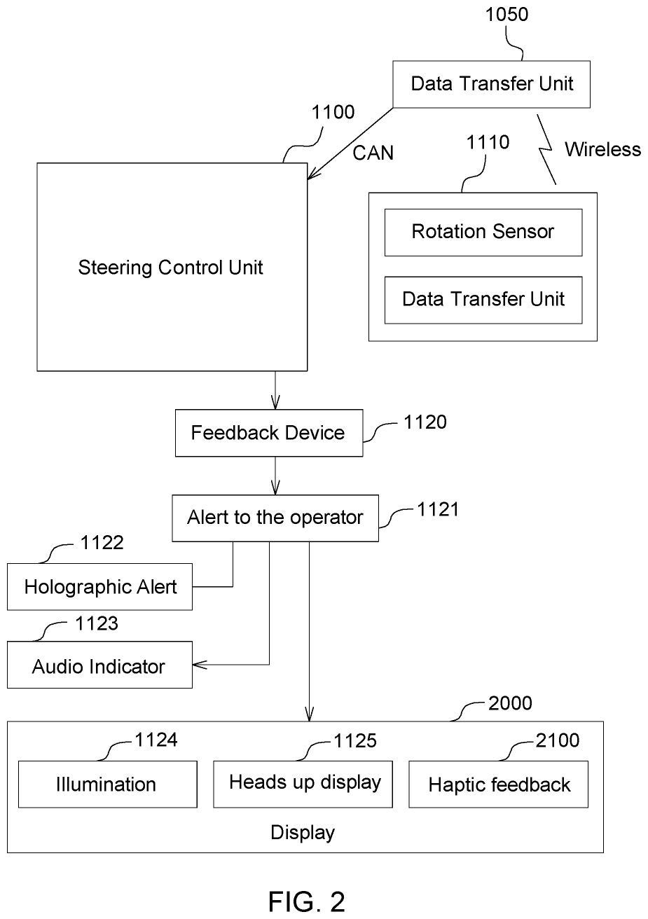

As can be seen in FIG. 2, the data transfer unit 1050 transfers a signal from various on-board steering sensors including movement module 1110 to one or more vehicle controllers including steering control unit 1100. As described previously, the data transfer unit 1050 is one of many nodes on a CAN bus. It can be appreciated by one of ordinary skill that the wireless communication between movement module 1110 and data transfer unit 1050 can comprise any number of means capable of providing a robust, high signal to noise ratio capability and without power supply wires running between the data transfer unit 1050 and the movement module 1110. For example, movement module 1110 may comprise a wireless communication device utilizing any number of modulation techniques such as the following bands: radio, optical, light or audible. In on example, wireless communication takes place using infrared or near field communication methods.

Upon determining the wireless signals from the movement module 1110 satisfy the threshold criteria, the automated steering mode is disabled and the operator 10 has full manual control of the vehicle steering system 1000. In one example, feedback is provided to the operator 10 that automated steering mode has been disabled and manual control is enabled. Feedback can also be provided to the operator that the battery of the movement module 1110 has low power or that the signal quality or strength of movement signal 1111 is poor. This information is provided to the operator 10 with the help of feedback device 1120. This feedback device 1120 can communicate wirelessly with any of the movement module 1110, data transfer unit 1050 or steering control unit 1100. In one example, the feedback device 1120 can generate an alert 1121 to the operator 10 in the form of a holographic visual alarm 1122, an audio indicator 1123, illumination 1124 or haptic interface 2100 on display 2000, heads-up display alerts 1125 or a visual indication on primary or secondary display units 2000. Such an alert 1121 could also be provided prior to conversion of automated steering mode into manual mode.

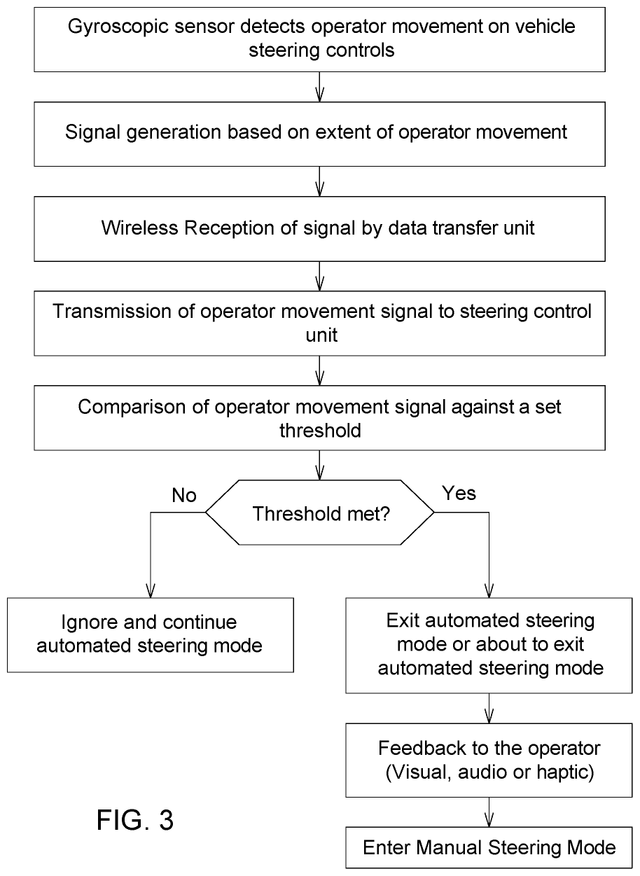

FIG. 3 describes a method of overriding automated steering by operator intervention. In a first step, movement of any steering component (e.g., a steering wheel 1003) of vehicle steering system 1000 by an operator 10 is detected using movement module 1110. The movement module 1110 then generates a corresponding movement signal 1111 which, in one example, represents at least one of rotation information, power information and signal information as previously described. This movement signal 1111 is wirelessly transmitted to the data transfer unit 1050 on the CAN bus. The data transfer unit 1050 then sends the movement signal 1111 to the steering control unit 1100 of vehicle steering system 1000. Upon reception and processing of the movement signal 1111—which may include comparison against threshold sensitivity criteria as previously described—the automated steering mode is disabled, and manual steering is activated. The operator 10 can then maneuver the vehicle 20 as per the operator's requirement. In one example, the following steps may be utilized:
1) detecting with the movement module 1110, movement of the vehicle steering mechanism 1003 by an operator 10;
2) generating a movement signal 1111 using the movement module 1110, the signal corresponding to at least one of rotation information, power information or signal information;
3) transmitting wirelessly the movement signal 1111 to a data transfer unit 1050;
4) transmitting the movement signal 1111 via the data transfer unit 1050 on a CAN bus network to the steering control unit 1100;
5) comparing the movement signal 1111 against one or more threshold sensitivity criteria; and
5) disabling an automated steering mode of the vehicle steering system 1000 thereby allowing the operator 10 to steer the vehicle 20 manually using vehicle steering mechanism 1003.

In one embodiment, the steering control unit 1100 may be comprised of one or more of software and/or hardware in any proportion. In such an example, this control unit 1100 may reside on a computer-based platform such as, for example, a server or set of servers. Any such server or servers may be a physical server(s) or a virtual machine(s) executing on another hardware platform or platforms. Any server, or for that matter any computer-based system, systems or elements described herein, will be generally characterized by one or more processors and associated processing elements and storage devices communicatively interconnected to one another by one or more busses or other communication mechanism for communicating information or data. In one example, storage within such devices may include a main memory such as, for example, a random access memory (RAM) or other dynamic storage devices, for storing information and instructions to be executed by the processor(s) and for storing temporary variables or other intermediate information during the use of the system and computing element described herein.

In one example, the control unit 1100 may also include a static storage device such as, for example, read only memory (ROM), for storing static information and instructions for the processor(s). In one example, the control unit 1100 may include a storage device such as, for example, a hard disk or solid-state memory, for storing information and instructions. Such storing information and instructions may include, but not be limited to, instructions to compute, which may include, but not be limited to processing and analyzing steering system data or information of all types. Such data or information may pertain to, but not be limited to, steering angle, hydraulic fluid levels, etc.

In one example, the processing and analyzing of data by the control unit 1100 may pertain to processing and analyzing steering system signals obtained from onboard sensors, movement module 1110, and issue alerts 1121 if required based on pre-defined acceptability parameters. RAMs, ROMs, hard disks, solid state memories, and the like, are all examples of tangible computer readable media, which may be used to store instructions which comprise processes, methods and functionalities of the present disclosure. Exemplary processes, methods and functionalities of the control unit 1100 may include determining a necessity for generating and presenting alerts in accordance with examples of the present disclosure. Execution of such instructions causes the various computer-based elements of control unit 1100 to perform the processes, methods, functionalities, operations, etc., described herein. In some examples, the control unit 1100 of the present disclosure may include hard-wired circuitry to be used in place of or in combination with, in any proportion, such computer-readable instructions to implement the disclosure.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the systems, methods, processes, apparatuses and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

The foregoing detailed description has set forth various embodiments of the systems, apparatuses, devices, methods and/or processes via the use of block diagrams, schematics, flowcharts, examples and/or functional language. Insofar as such block diagrams, schematics, flowcharts, examples and/or functional language contain one or more functions and/or operations, it will be understood by those within the art that each function and/or operation within such block diagrams, schematics, flowcharts, examples or functional language can be implemented, individually and/or collectively, by a wide range of hardware, software, firmware, or virtually any combination thereof. In one example, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the type of signal bearing medium used to carry out the distribution. Examples of a signal bearing medium include, but are not limited to, the following: an edge computing module or device; a computer readable memory medium such as a magnetic medium like a floppy disk, a hard disk drive, and magnetic tape; an optical medium like a Compact Disc (CD), a Digital Video Disk (DVD), and a Blu-ray Disc; computer memory like random access memory (RAM), flash memory, and read only memory (ROM); and a transmission type medium such as a digital and/or an analog communication medium like a fiber optic cable, a waveguide, a wired communications link, and a wireless communication link.

The herein described subject matter sometimes illustrates different components associated with, comprised of, contained within or connected with different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two or more components herein combined to achieve a particular functionality can be seen as “associated with” each other such that the desired functionality is achieved, irrespective of architectures or intermediate components. Likewise, any two or more components so associated can also be viewed as being “operably connected”, or “operably coupled”, to each other to achieve the desired functionality, and any two or more components capable of being so associated can also be viewed as being “operably couplable”, to each other to achieve the desired functionality. Specific examples of operably couplable include, but are not limited to, physically mateable and/or physically interacting components, and/or wirelessly interactable and/or wirelessly interacting components, and/or logically interacting and/or logically interactable components.

Unless specifically stated otherwise or as apparent from the description herein, it is appreciated that throughout the present disclosure, discussions utilizing terms such as “accessing,” “aggregating,” “analyzing,” “applying,” “brokering,” “calibrating,” “checking,” “combining,” “communicating,” “comparing,” “conveying,” “converting,” “correlating,” “creating,” “defining,” “deriving,” “detecting,” “disabling,” “determining,” “enabling,” “estimating,” “filtering,” “finding,” “generating,” “identifying,” “incorporating,” “initiating,” “locating,” “modifying,” “obtaining,” “outputting,” “predicting,” “receiving,” “reporting,” “retrieving,” “sending,” “sensing,” “storing,” “transforming,” “updating,” “using,” “validating,” or the like, or other conjugation forms of these terms and like terms, refer to the actions and processes of a computer system or computing element (or portion thereof) such as, but not limited to, one or more or some combination of: a visual organizer system, a request generator, an Internet coupled computing device, a computer server, etc. In one example, the computer system and/or the computing element may manipulate and transform information and/or data represented as physical (electronic) quantities within the computer system's and/or computing element's processor(s), register(s), and/or memory(ies) into other data similarly represented as physical quantities within the computer system's and/or computing element's memory(ies), register(s) and/or other such information storage, processing, transmission, and/or display components of the computer system(s), computing element(s) and/or other electronic computing device(s). Under the direction of computer-readable instructions, the computer system(s) and/or computing element(s) may carry out operations of one or more of the processes, methods and/or functionalities of the present disclosure.

Those skilled in the art will recognize that it is common within the art to implement apparatuses and/or devices and/or processes and/or systems in the fashion(s) set forth herein, and thereafter use engineering and/or business practices to integrate such implemented apparatuses and/or devices and/or processes and/or systems into more comprehensive apparatuses and/or devices and/or processes and/or systems. That is, at least a portion of the apparatuses and/or devices and/or processes and/or systems described herein can be integrated into comprehensive apparatuses and/or devices and/or processes and/or systems via a reasonable amount of experimentation.

Although the present disclosure has been described in terms of specific embodiments and applications, persons skilled in the art can, considering this teaching, generate additional embodiments without exceeding the scope or departing from the spirit of the present disclosure described herein. Accordingly, it is to be understood that the drawings and description in this disclosure are proffered to facilitate comprehension of the present disclosure and should not be construed to limit the scope thereof.

As used herein, unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

What is claimed is:

1. A vehicle steering system allowing for override of an automated steering mode, the system comprising:
a vehicle steering mechanism;
a movement module disposed on the vehicle steering mechanism, the sensor configured to detect movement of the vehicle steering mechanism of the vehicle steering system and generate a movement signal;
a data transfer unit in wireless communication with the movement module and configured to receive and transmit the movement signal; and
a steering control unit configured to allow for at least one of steering in a manual steering mode or an automated steering mode, the steering control unit in communication with the data transfer unit and configured to receive the movement signal and disable the automated vehicle steering mode upon receipt of the movement signal.

2. The system of claim 1 wherein the steering control unit compares the movement signal against position information, the position information comprising a series of recorded or future position points of a vehicle along a guidance line.

3. The system of claim 1 wherein the vehicle steering system comprises at least one feedback device indicating that automated vehicle steering mode has been disabled.

4. The system of claim 1 wherein the vehicle steering mechanism is a steering wheel and the movement module is attached to the steering wheel.

5. The system of claim 1 wherein the movement module communicates wirelessly via a data transfer unit to the steering control unit.

6. The system of claim 1 wherein the movement module is battery powered.

7. The system of claim 1 wherein the movement module is a rotation sensor.

8. The rotation sensor of claim 7 further comprising a vibrating structure gyroscope.

9. The system of claim 7 wherein the sensor is a micro-processor powered device with a microelectromechanical systems gyroscope.

10. The system of claim 1 wherein the wireless communication between the steering control unit and the movement module is conducted using modulation in at least one of an optical, radio, light or audible band.

11. The system of claim 1 further comprising a data transfer unit associated with the movement module and in wireless communication with the steering control unit, the data transfer unit receiving the movement signal from the movement module and transmitting the signal to the steering control unit.

12. The system of claim 1 wherein the steering control unit compares the movement signal against a predetermined threshold value and disables automated vehicle steering mode when the signal deviates from the threshold value.

13. The system of claim 12 wherein the movement signal comprises at least one of rotation information, battery information and signal strength information.

14. The system of claim 1 wherein the communication between the movement module and the data transfer unit is encrypted.

15. The system of claim 1 wherein the movement module and the data transfer unit are in paired communication with each other, the paired communication acting to prevent unwanted communication from an unpaired sensor or a control unit.

16. The system of claim 1 wherein the data transfer unit and the steering control unit communicate with each over a controller area network.

17. A method for overriding an automated steering mode of a vehicle, said method comprising:
providing a movement module on a vehicle steering mechanism;
detecting with the movement module movement of the vehicle steering mechanism by an operator;
generating and transmitting a movement signal using the movement module, the movement signal corresponding to movement of the vehicle steering mechanism;
receiving wirelessly the movement signal at a data transfer unit, the data transfer unit configured to receive and transmit the movement signal to steering control unit; and
disabling, with the steering control unit, an automated vehicle steering mode thereby allowing the operator to steer the vehicle manually using the vehicle steering mechanism.

18. A vehicle steering apparatus, the apparatus comprising:
a vehicle steering mechanism;
a movement module disposed on the vehicle steering mechanism, the sensor configured to generate and transmit a movement signal corresponding to movement of the vehicle steering mechanism;
a data transfer unit in wireless communication with the movement module, the data transfer configured to receive and transmit the movement signal; and
a steering control unit configured to receive the movement signal from the data transfer, compare the movement signal against a predetermined threshold value, and disable an automated vehicle steering mode when the movement signal satisfies the predetermined threshold value.

19. The apparatus of claim 18 wherein the movement signal not satisfying the predetermined threshold value is at least one of an over-threshold or under-threshold value.
